(19) United States
(12) Patent Application Publication
(10) Pub. No.: US 2005/0157382 A1
(43) Pub. Date: Jul. 21, 2005

(54) Industrial directly diode-pumped ultrafast amplifier system

(76) Inventors: James D. Kafka, Palo Alto, CA (US); Jianping Zhou, Palo Alto, CA (US); Juerg Aus-Der-Au, Mountain View, CA (US); Kevin Holsinger, Menlo Park, CA (US); Ventzislav Stoev, Fremont, CA (US)

Correspondence Address: HELLER EHRMAN LLP, 275 MIDDLEFIELD ROAD, MENLO PARK, CA, 94025-3506, US

(21) Appl. No.: 11/031,500

(22) Filed: Jan. 7, 2005

Related U.S. Application Data
(60) Provisional application No. 60/535,080, filed on Jan. 7, 2004.

(51) Int. Cl. H01S 3/098

(52) U.S. Cl. 359/346

(57) ABSTRACT

A directly diode-pumped amplifier system is disclosed which produces sub-picosecond pulses with an output power of 2 watts or more. Computer resources are coupled to the amplifier system and are configured to provide control of operating parameters of the amplifier system. An optional second harmonic generator is supplied to increase the contrast ratio and reduce the minimum focal spot size. This amplifier system can be utilized for material processing applications.

### CROSS REFERENCE TO RELATED APPLICATION

This application claims the benefit of provisional Application No. 60/535,080, filed Jan. 7, 2004, and U.S. Ser. No. 10/762,216 filed Jan. 20, 2004, both of which are fully incorporated by reference.

### BACKGROUND

1. Field of the Invention

This invention relates generally to ultrafast amplifier systems, and their methods of use, and more particularly to ultrafast amplifier systems with direct diode pumping of the gain media, and their methods of use.

2. Description of the Related Art

Ultrafast amplifier systems have been used in both scientific and industrial applications for the last decade. The most common system uses Ti:sapphire as the gain media and produces about 1 mJ of energy at 1 kHz repetition rate with a pulse duration of 150 fs. While these systems have found wide use in scientific applications, they do not fully satisfy the need for an industrial ultrafast amplifier. The Ti:sapphire system requires green pump lasers for both the oscillator and amplifier and a directly diode-pumped system is needed to satisfy the desire for a simpler and more robust system. Industrial applications also need higher average powers and consequently higher repetition rates but can tolerate longer pulse durations, possibly as long as 1 ps. A minimum energy of several hundred microjoules is also required for many applications.

Several directly diode-pumped materials have been considered for an industrial ultrafast amplifier. Nd:YAG, Nd:YLF and Nd:YVO₄ have all been used and produce high average powers but the pulse durations produced are all greater than 1 ps. Shorter pulse durations have been produced using Nd:glass and several Yb doped materials including Yb doped fibers, bulk Yb:glass, Yb:SYS, Yb:KGW and Yb:KYW. All of these systems produce subpicosecond pulses but most have not produced pulse energies of more than 200 microjoules. The few that have generated more than 200 microjoules, all operate at lower repetition rates and thus average powers of 1 W or less. This is because the thermal conductivity is small for the bulk Yb doped gain media and thus scaling to higher powers is problematic.

A cw Yb:YAG laser has been demonstrated using a thin disk geometry by U. Brauch et al. in Optics Letters vol. 20 page 713 (1995). They calculated that an amplifier could be constructed that would produce 200 fs pulses with 10 W of average power at 2 kHz yielding a pulse energy of 5 mJ, however no details were given and no high energy system has been demonstrated.

There is a need for an ultrafast amplifier system that produces subpicosecond pulses with sufficient energy and average power and is sufficiently robust for material processing applications.

### SUMMARY

An object of the present invention is to provide an improved ultrafast amplifier system, and its methods of use.

Another object of the present invention is to provide an improved ultrafast amplifier system, and its methods of use, with direct diode pumping of the gain media.

A further object of the present invention is to provide an improved ultrafast amplifier system, and its methods of use, with computer resources that provide control of various operating parameters of the amplifier system.

These and other objects of the present invention are achieved in an amplifier system with first and second reflectors that define an amplifier cavity. A gain media is positioned in the amplifier cavity. A diode pump source directly pumps the gain media and the amplifier system produces sub-picosecond pulses with an output power of 2 watts or more. Computer resources are coupled to the amplifier system and are configured to provide control of operating parameters of the amplifier system.

In another embodiment of the present invention, an amplifier system includes first and second reflectors that define an amplifier cavity. A gain media is positioned in the amplifier cavity. A diode pump source directly pumps the gain media and the amplifier system produces sub-picosecond pulses with an output power of 2 watts or more. A frequency conversion device is included and receives a fundamental wavelength output from the amplifier and produces a second harmonic wavelength output. Third harmonic, fourth harmonic, fifth harmonic and sixth harmonic generators may also be included.

In another embodiment of the present invention, a method is provided for material processing. An amplifier system is provided that has a diode pump source configured to directly pump a gain media. The amplifier system includes computer resources to control the operating parameters of the amplifier system. An output beam of sub-picosecond pulses is produced with an output power of 2 watts or more. The output beam is applied to a material.

### BRIEF DESCRIPTION OF THE DRAWINGS

FIG. 1 is a schematic diagram of one embodiment of an amplifier system of the present invention that includes computer resources utilized for control of the amplifier operating parameters. An optional frequency conversion device is also included.

### DETAILED DESCRIPTION

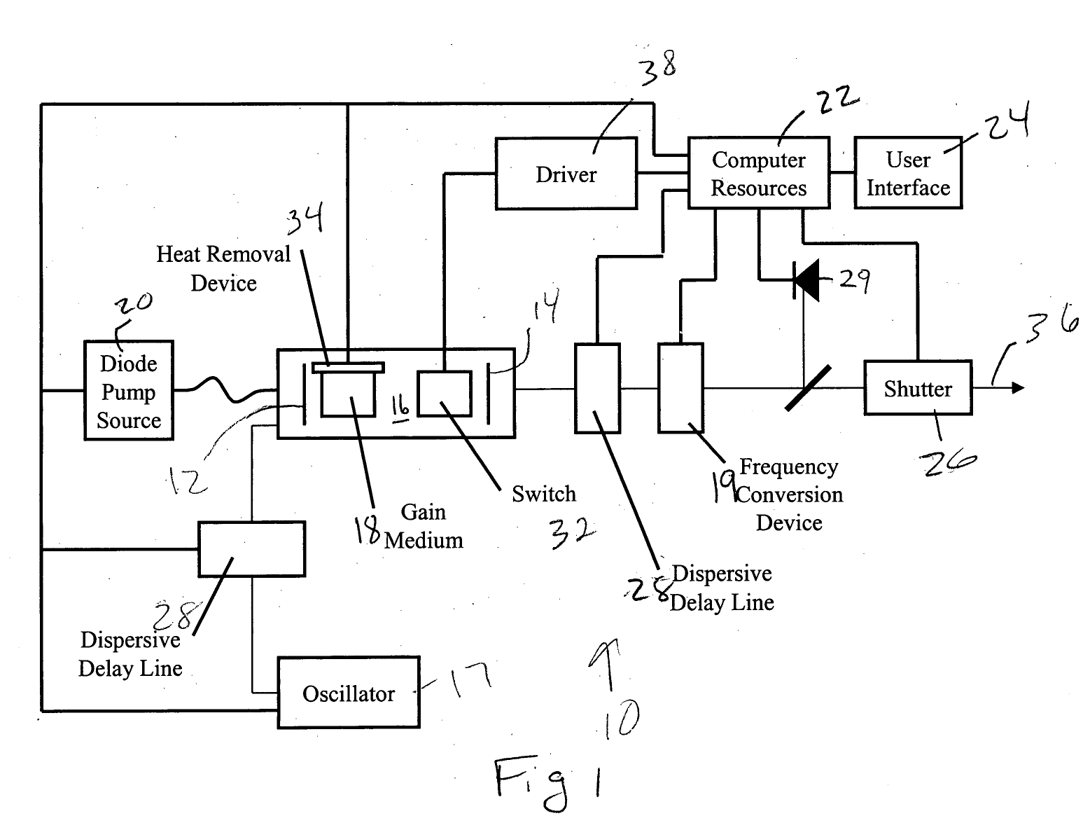

Referring now to FIG. 1, one embodiment of an amplifier system 10 of the present invention includes first and second reflectors 12 and 14 that define an amplifier cavity 16. An oscillator 17 provides a seed pulse to the amplifier system. The amplifier system 10 can be a chirped pulsed amplifier which contains a stretcher and compressor which are both dispersive delay lines using gratings. Alternatively, the stretching and/or compressing can be done by prism pairs, optical fibers, photonic crystal fibers, Gires-Toumois interferometers, chirped mirrors, material dispersion in the amplifier, and the like.

Again media 18 is positioned in the amplifier cavity 16. A variety of gain media 18 can be utilized including but not limited to, Yb:KGW, Yb:KYW, KYbW, Yb:KLuW, Yb:YAG, YbAG, Yb:YLF, Yb:SYS, Yb:BOYS, Yb:YSO, Yb:CaF₂, Yb:Sc₂O₃, Yb:Y₂O₃, Yb:Lu₂O₃, Yb:GdCOB, Yb:glass and Nd:glass. The gain media 18 can also be epitaxially grown or made of a ceramic material. In certain embodiments, the gain media 18 is selected from Yb:KGW, Yb:KYW and KYbW. In one embodiment, the gain media 18 is kept in a dry atmosphere to prevent condensation. This can be done by sealing the entire amplifier cavity 16 or by providing a compartment around the gain media 18 with AR coated windows for the pump and amplifier beams to pass through.

In one embodiment, a length and doping of the gain media 18 are selected to minimize heating of the gain media 18. By way of illustration, and without limitation, the Yb doping can be between 1% to 10%, 2% to 5%, and the length of the gain media 18 can be between 2 mm and 20 mm, 4 mm and 12 mm, and the like.

In one embodiment, at least a portion of the gain media 18 has beveled edges to reduce defects. Optionally, a post-processing step, including but not limited to annealing, can be used to relieve stress and reduce defects. The gain media 18 can be used at an orientation to optimize the absorption, gain, gain bandwidth, pulse duration, thermal conductivity and expansion and minimize nonlinear optical effects, thermo-mechanical and thermo-optical effects. In this regard the direction of propagation through the gain media 18 and the polarization used can be chosen to optimize the gain, the bandwidth and/or the threshold for Raman generation. In one embodiment, the gain media 18 has a thin disk geometry, where the length of the gain media 18 is less than the width of the gain media. Additionally, the length of the gain media 18 can be less than the diameter of the pump beam. By way of illustration, and without limitation, the pump beam diameter can be from 100 microns to 2 mm, and the thickness of the thin disk gain media 18 can be from 50 to 1000 microns. The Yb doping of the thin disk can range from 5% to 100%.

A diode pump source 20 is provided. Diode pump source 20 directly pumps the gain media 18. Suitable diode pump sources 20 include but are not limited to, diode bars, diode stacks, fiber-coupled diode bars with multiple fibers in the bundle, single fiber-coupled laser diode bars, optically pumped semiconductor light sources and the like. The single fiber coupled bars can provide a high brightness pump source. By way of illustration, and without limitation, single fiber coupled bars can produce 30 W of pump power from a fiber that has a diameter of 200 to 400 microns and a numerical aperture of 0.22. Pumping the gain media 18 directly with the pump source 20 is more efficient, cost effective and robust than using the pump source 20 to pump a laser which then pumps the gain media 18.

In one embodiment, the amplifier system 10 produces sub-picosecond pulses with an output power of 2 watts or more. Suitable pulse durations can range from about 100 fs to 1 picosecond while still producing the desired effects that are suitable for a variety of different applications, including but not limited to materials processing. In another embodiment, a frequency conversion device 19, is provided. Computer resources 22 are coupled to the amplifier system 10 and configured to provide control of operating parameters of the amplifier system 10, as more fully described hereafter. A user interface 24 is provided. At the user interface 24, an operator of amplifier system 10 can enter values for operating parameters including but not limited to the repetition rate of the amplifier system 10, adjust a shutter 26, adjust a length of a dispersive delay line 28, adjust the frequency conversion device 19, adjust a driver 30 to a switch 32 in the amplifier cavity 16 and the like.

Amplifier system 10 can include a Pockels cell as the intra-cavity switch 32. Other suitable devices for the switch 32 include but are not limited to, acousto-optics switches and the like. In one embodiment, the operating parameters can include but are not limited to a, (i) voltage level directed to the Pockels cell 32, (ii) timing of voltage to the Pockels cell 32, (iii) length of the dispersive delay line 28 and a repetition rate of the amplifier system 10, (iv) drive current and temperature of the diode pump source 20, (v) temperature of the gain media 18, (vi) angle and temperature of the frequency conversion device 19, and the like. In one embodiment, the voltage level and the timing of the voltage to the Pockels cell 32 are used to optimize energy and minimize pre-pulses. The dispersive delay line 28 can be used to optimize output pulse duration. In one embodiment, in the event of a change of the repetition rate of the amplifier system 10, some of the voltage, timing and delay line are re-optimized. When the repetition rate of the amplifier system 10 is increased, the gain is decreased and a larger number of round trips are required in the amplifier cavity. The timing of the high voltage to the Pockels cell 32 is then adjusted to stay on longer and achieve the increased number of round trips to maximize the energy of the pulse. Since the number of round trips has increased, the length of the dispersive delay line 28 also needs to be adjusted in order to compensate and produce the shortest pulse.

In one embodiment, at least a portion of the operating parameters drift over time. For example, the value of the high voltage may not always be optimal to produce the maximum contrast ratio or the optimum stability of the output power. The operating parameters can be used in a calibration mode of the amplifier system 10. That is, the value for the operating parameters can each be varied sequentially, or a genetic algorithm or fuzzy logic, can be used in order to optimize the energy, contrast ratio, pulse duration, system stability and/or conversion efficiency of the frequency conversion device 19. The calibration mode can be run when, (i) at least a portion of the operating parameters drift over time, (ii) a parameter of the amplifier system 10 is changed, (iii) a repetition rate of the system is changed, (iv) the stability of the output power degrades, (v) the pump level to the gain media is adjusted, and the like.

Alternatively, the computer resources 22 can store target values for the operating parameters for each repetition rate. By way of illustration, and without limitation, examples of target values can include, the optimal timing for the high voltage and length of the dispersive delay line 28 to yield the highest pulse energy and shortest pulse for each repetition rate, as described above.

In one embodiment, the operating parameters are adjusted continuously and automatically by the computer resources 22. For example, generating the second harmonic of the fundamental pulse can generate an error signal. This signal is directed to a photodiode 29 and is dependent on the pulse duration. If the pulse duration drifts the signal will decrease. The length of the dispersive delay line 28 can then be adjusted automatically until the second harmonic signal is increased to either its original value or to a maximum value.

Examples of error signals include but are not limited to, the energy of the second harmonic of the fundamental output pulse, the fundamental pulse energy itself, the stability of the output power, the magnitude of the pre-pulses as measured using a boxcar integrator, for example, an error signal generated directly from the material processing application, and the like. In one embodiment, a heat removal device 34 is coupled to the gain media 18 and is configured to allow the gain media 18 to scale to higher powers. The gain media 18 is coupled to the heat removal device 34 by any number of ways including but not limited to brazing, surface activated bonding, and the like. By way of illustration, and without limitation, the gain media 18 can be coated with gold and braised to the heat removal device 34 using evaporated indium or indium foil. The heat removal device 34 can be made from copper or copper-tungsten or similar materials.

In one embodiment the heat removal device 34 includes a TE cooler. It will be appreciated that the present invention is not limited to a TE cooler, and other devices can be utilized including but not limited to, a cryogenic cooler, a thin film cooler, a heat pipe and the like. In one embodiment, the heat removal device 34 operates at a temperature less than 10 degree Celsius. The heat removal device 34 provides cooling of the gain media 18 to improve the gain, increase the gain bandwidth, increase the thermal conductivity and thus reduce a thermal gradient and/or reduce the absorption of a pumped gain media 18.

In another embodiment of amplifier system 10, a frequency conversion device 19 is provided. The frequency conversion device 19 receives a fundamental wavelength output and produces a second harmonic wavelength output. Alternatively, the frequency conversion device can produce a third, fourth, fifth or sixth harmonic of the fundamental wavelength. A variety of materials can be used for frequency conversion device 19 including but not limited to, BBO, KDP, KD*P, CLBO, LBO and the like. In one embodiment, an efficiency of the second harmonic frequency conversion device 19 is at least 50%.

In one embodiment of the present invention, the fundamental wavelength output from the gain media 18 is from 1030 to 1050 nm, and the second harmonic wavelength is from 515 to 525 nm. Other directly diode-pumped gain media operate in the wavelength range from 1020 to 1080 nm with the second harmonic wavelength then ranging from 510 to 540 nm, the third harmonic wavelength from 340 nm to 360 nm, the fourth harmonic wavelength from 255 to 270 nm, the fifth harmonic wavelength from 204 to 216 nm and the sixth harmonic wavelength from 170 to 180 nm. The second harmonic wavelength in the green can be particularly suitable for material processing applications because optical components such as mirrors and AR coated lenses have long lifetimes at this wavelength. The lifetime of optical components becomes increasingly problematic at shorter wavelengths.

The second harmonic wavelength output can be focused to a spot that is substantially smaller in radius than the diffraction limited spot size of the fundamental wavelength output. This is because when the wavelength is reduced by a factor of two the diffraction limit is also reduced by a factor of two. Thus if the smallest spot that can be generated with a given lens and working distance is 2 microns for the fundamental, the second harmonic output can be focused to a 1 micron spot size.

Frequency conversion by frequency conversion device 19 can increase a contrast ratio of amplifier system 10. By way of illustration, and without limitation, the contrast ratio between the main pulse and the pre-pulses is typically 10³ for the fundamental wavelength. These pre-pulses can be detrimental to material processing applications because they can preheat the sample prior to the arrival of the main pulse. Frequency doubling is a quadratic process, thus the efficiency depends on the input intensity. As a result, the conversion efficiency that the main pulse experiences is 50% while the efficiency for the pre-pulses will be much lower, typically only 1%. Thus the frequency doubling increases the contrast ratio to a value of 10⁵ to 10⁶. The same effect applies to the post-pulses where the contrast ratio will increase from 10² to as much as 10⁴.

In one embodiment, the fundamental output has an energy of at least 200 microjoules. In another embodiment, the second harmonic output has an energy of at least 100 microjoules.

Amplifier system 10 can be utilized for a variety of different applications, including but not limited to material processing. The output beam 36, can be directed to an imaging system, a scanning system or the like before being incident on the target material. Suitable materials processing applications include but are not limited to, micro-machining, ablation, marking, modification of a material structure, writing of optical waveguides, and the like. Ultrafast pulses of the present invention are desirable for micro-machining because the sample is not heated as much as with longer pulses and the heat affected zone (HAZ) is thus reduced. Ultrafast pulses of the present invention can be used in ablation applications because they provide greater control over the amount of material that is ablated. Examples of ablation processes include but are not limited to, removing thin films from on top of dissimilar materials. Ultrafast pulses of the present invention are used to write waveguides in transparent materials for integrated optics applications. These ultrafast pulses allow the index of the material to be modified appropriately without heating the surrounding material.

### EXAMPLE 1

The ultrafast pulses of the present invention are used at the fundamental wavelength of 1048 nm to machine various materials. In one embodiment, 50 micron diameter round holes are drilled through 1 mm thick hardened steel. Using 2.5 W of average power at 5 kHz repetition rate, the holes are completed in 20 seconds.

### EXAMPLE 2

In this example, ultrafast pulses of the present invention are used for scribing of borosilicate glass with 30-micron wide, chip-free grooves. This is done at 2 kHz repetition rate and a scan speed of at least 10 mm/sec.

### EXAMPLE 3

In this example, ultrafast pulses of the present invention are used for scribing of the nanocomposite Morthane with 26 micron wide and 20 micron deep clean grooves generated. The repetition rate is 5 kHz and 10 passes are required and a scan speed of at least 40 mm/sec can be used to generate these grooves.

### EXAMPLE 4

In this example, ultrafast pulses of the present invention are used for the cutting of 770 micron thick white Teflon using 2.4 W average power at 5 kHz repetition rate. The cutting of clean grooves is done with 50 repeated passes and a scan speed of 50 mm/sec.

The foregoing description of various embodiments of the present invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

1. An amplifier system, comprising:
a first and a second reflector defining an amplifier cavity;
a gain media positioned in the amplifier cavity;
a diode pump source configured to directly pump the gain media, the amplifier system producing sub-picosecond pulses with an output power of 2 watts or more;
computer resources coupled to the amplifier system and configured to provide control of operating parameters of the amplifier system.

2. The system of claim 1, the gain media is selected from, Yb:KGW, Yb:KYW, KYbW, Yb:KLuW, Yb:YAG, YbAG, Yb:YLF, Yb:SYS, Yb:BOYS, Yb:YSO, Yb:CaF, Yb:Sc₂O₃, Yb:Y₂O₃, Yb:Lu₂O₃, Yb:GdCOB, Yb:glass and Nd:glass.

3. The system of claim 1, wherein the gain media is selected from Yb:KGW, Yb:KYW and KYbW.

4. The system of claim 1, further comprising:
a heat removal device coupled to the gain media and configured to scale the output from the gain media to higher powers.

5. The system of claim 4, wherein the heat removal device includes a TE cooler.

6. The system of claim 4, wherein the heat removal device operates at a temperature less than 10 degree Celsius.

7. The system of claim 5, wherein the gain media is kept in a dry atmosphere to prevent condensation.

8. The system of claim 4, wherein the heat removal device provides cooling of the gain media to improve thermal conductivity and thus reduce a thermal gradient of a pumped gain media.

9. The system of claim 1, wherein a length and doping of the gain media are selected to minimize heating of the gain media.

10. The system of claim 4, wherein the gain media is brazed to the heat removal device.

11. The system of claim 1, wherein at least a portion of the gain media has beveled edges to reduce defects.

12. The system of claim 1, wherein the gain media is used at an orientation to optimize at least one of, the absorption, gain, gain bandwidth, pulse duration, thermal conductivity and expansion and minimize nonlinear optical effects, thermo-mechanical and thermo-optical effects.

13. The system of claim 1, wherein the gain media has a thin disk geometry.

14. The system of claim 1, wherein the amplifier is a chirped pulsed amplifier.

15. The system of claim 1, further comprising a Pockels cell.

16. This system of claim 1, wherein the diode pump source is one or more single fiber coupled laser diode bars.

17. The system of claim 15, wherein the operating parameters include at least one of, a voltage level directed to the Pockels cell, timing of voltage to the Pockels cell, length of a dispersive delay line, drive current and temperature of the diode pump source, temperature of the gain media, the angle and temperature of the frequency conversion device and a repetition rate of the system.

18. The system of claim 17, wherein the voltage level and the timing of the voltage to the Pockels cell are used to optimize energy and minimize pre-pulses.

19. The system of claim 17, wherein the length of the dispersive delay line is used to optimize output pulse duration.

20. The system of claim 17, wherein in the event of a change of the repetition rate of the system, some of the voltage, timing and delay line are re-optimized.

21. The system of claim 1, further comprising:
a user interface.

22. The system of claim 1, wherein at least a portion of the operating parameters drift over time.

23. The system of claim 22, wherein error signals indicative of a change in an operating parameter are generated.

24. The system of claim 23, wherein at least one of the error signals is the second harmonic of the fundamental output pulse.

25. The system of claim 1, wherein the computer controlled operating parameters are used in a calibration mode of the system.

26. The system of claim 25, wherein a calibration mode is run when at least a portion of the operating parameters drift over time.

27. The system of claim 25, wherein a calibration mode is run when a parameter of the system is changed.

28. The system of claim 25, wherein a calibration mode is run when a repetition rate of the system is changed.

29. The system of claim 1, wherein the computer stores target values for the operating parameters for each repetition rate.

30. The system of claim 1, wherein the operating parameters are adjusted automatically.

31. An amplifier system, comprising:
a first and a second reflector defining an amplifier cavity;
a gain media positioned in the amplifier cavity;
a diode pump source configured to directly pump the gain media, the amplifier system producing sub-picosecond pulses with an output power of 2 watts or more; and
a frequency conversion device that receives a fundamental wavelength output from the amplifier and produces a second harmonic wavelength output.

32. The system of claim 31 in which the frequency conversion device produces a third, fourth, fifth or sixth harmonic wavelength.

33. The system of claim 31, wherein the frequency conversion device is made of at least one of BBO, KDP, KD*P, CLBO and LBO.

34. The system of claim 31, wherein an efficiency of the frequency conversion device is at least 50%.

35. The system of claim 31, wherein fundamental wavelength output from the gain media is from 1030 to 1050 nm, and the second harmonic wavelength is from 515 to 525 nm.

36. The system of claim 31 wherein the second harmonic wavelength output is focused to a spot that is substantially smaller in radius than the diffraction limited spot size of the fundamental wavelength output.

37. The system of claim 31, wherein frequency conversion increases a contrast ratio of the system.

38. The system of claim 31, wherein frequency conversion increases a contrast ratio of the system by a factor of at least 10.

39. The system of claim 31, wherein frequency conversion increases a contrast ratio of pre-pulses to as much as 10⁴.

40. The system of claim 31, wherein frequency conversion reduces a pulse duration of the fundamental by 2 to 10 times.

41. The system of claim 1, wherein the fundamental output has an energy of at least 200 microjoules.

42. The system of claim 31, wherein the second harmonic output has an energy of at least 100 microjoules.

43. A method of material processing, comprising:
providing an amplifier system that has a diode pump source configured to directly pump a gain media, the amplifier system including computer resources to control the operating parameters of the amplifier system;
producing an output beam of sub-picosecond pulses with an output power of 2 watts or more; and
applying the output beam to a material for the material processing.

44. The method of claim 43, wherein the material processing is micro-machining.

45. The method of claim 43, wherein the material processing is ablation.

46. The method of claim 43, wherein the material processing is marking.

47. The method of claim 43, wherein the material processing is a modification of a material structure.

48. The method of claim 43, wherein the material processing is a writing of optical waveguides.

49. The method of claim 43, wherein the amplifier system includes a frequency conversion device that receives a fundamental wavelength output from the gain media and produces a second harmonic wavelength output.

50. The system of claim 43, wherein the amplifier system includes a frequency conversion device that receives a fundamental wavelength output from the gain media and produces a third, fourth, fifth or sixth harmonic wavelength.

51. The method of claim 49, further comprising:
producing an efficiency of the frequency conversion device of at least 50%.

52. The method of claim 49, wherein the fundamental wavelength output from the gain media is from 1030 to 1050 nm, and the second harmonic wavelength is from 515 to 525 nm.

53. The method of claim 49, further comprising:
focusing the second harmonic wavelength output to a spot that is substantially smaller in radius than the diffraction limited spot size of the fundamental wavelength output.

54. The method of claim 49, further comprising:
increasing a contrast ratio of the system.

55. The method of claim 49, further comprising:
increasing a contrast ratio of the system by a factor of at least 10.

56. The method of claim 49, further comprising:
increasing a contrast ratio of pre-pulses to as much as 10⁴.

57. The method of claim 49, further comprising:
reducing a pulse duration of the fundamental by 2 to 10 times.
